(19) United States
(12) Patent Application Publication
(10) Pub. No.: US 2010/0094479 A1
(43) Pub. Date: Apr. 15, 2010

(54) System and Method for Providing Voltage Control in a Power Line Distribution Network

(76) Inventor: Robert A. Keefe, Honeoye Falls, NY (US)

Correspondence Address: CAPITAL LEGAL GROUP, LLC, 1100 River Bay Road, Annapolis, MD, 21409, US

(21) Appl. No.: 12/249,498

(22) Filed: Oct. 10, 2008

(51) Int. Cl. G05D 9/12

(52) U.S. Cl. 700/298

(57) ABSTRACT

A system, method and device for controlling the voltage supplied to a customer premises that is supplied power from a substation via a power distribution network is provided and wherein a resident of the customer premises obtains internet access service via an internet access network. In one embodiment, the method includes measuring a voltage at an electrical outlet of the customer premises to provide voltage data with the device, determining whether the measured voltage is beyond a threshold voltage with the device or a remote computer, transmitting the voltage data over the internet access network of the customer premises to the remote computer from the device, and adjusting a voltage supplied to the power distribution network by the substation if the voltage is beyond a threshold voltage. The method may also include processing at least some of the received voltage data at the remote computer to determine whether to increase a voltage supplied by the substation or decrease a voltage supplied by the substation and further to determine an amount of the increase or decrease (if any).

### FIELD OF THE INVENTION

The present invention generally relates to voltage conservation and more particularly, to a system and method for monitoring and adjusting a voltage supplied to a power grid to thereby reduce power consumption.

### BACKGROUND OF THE INVENTION

The economic and environmental cost of generating and distributing power to power customers is enormous. Even a small percentage reduction in power consumption translates to an enormous financial savings and reduced emissions.

FIG. 1 illustrates a conventional power grid 1110. Power is carried from the substation 14 to one or more distribution transformers 60 over one or more MV power lines 20. Power is carried from the distribution transformer 60 to the customer premises 40 via one or more LV power lines 61. Customer premises 40 include a low voltage premises network 55 that provides power to individual power outlets within the customer premises 40.

A distribution transformer 60 may function to distribute one, two, three, or more phases of power to the customer premises 40, depending upon the demands of the user. In the United States, for example, these local distribution transformers 60 typically feed anywhere from one to ten homes, depending upon the concentration of the customer premises 40 in a particular area. Distribution transformers 60 may be pole-top transformers located on a utility pole, pad-mounted transformers located on the ground, or transformers located under ground level.

While FIG. 1 depicts only a single customer premises 40, in practice MV power lines 20 extend for considerable distances and provide power to numerous homes and business customers. The voltage supplied to those power customers that are farthest from the substation may be considerably less than the voltage supplied to nearby power customers because of losses caused by the power distribution system. During power distribution, the voltage supplied to the medium voltage power line 10 by substation 14 must be maintained so that the voltage at all the customer premises satisfies regulatory requirements. Utilities typically must make an educated “guess” as to the voltage required to be supplied by the substation 14 based on an estimated voltage drop to the power customers receiving the lowest voltages. The voltage supplied by the substation is set according to this voltage drop.

A voltage drop is typically estimated for the customer premises 40 that are the farthest distances from the substation 14, which are assumed to experience the greatest voltage drop. However, a margin of error must be added to the estimated voltage drop (or to the voltage estimated to be received by the power customers) due to the uncertainty of the losses of various components of the power grid 1110 such as, for example, transformer losses and distribution in losses. Thus, a voltage provided by a substation 14 is set based on an educated “guess” of the voltage drop plus an added voltage to provide a margin of error. Setting a voltage based on an educated “guess” and a margin of error often results in the utility providing a voltage that is higher than required by regulatory requirements, which in some instances causes a greater than necessary delivery of power. Currently, there is no cost efficient means for an electric utility to accurately determine the voltage to be supplied by a substation 14 to provide a desired voltage at a customer premises. These and other advantages are provided by various embodiments of the present invention.

### SUMMARY OF THE INVENTION

The present invention provides a system, method and device for controlling the voltage supplied to a customer premises that is supplied power from a substation via a power distribution network and wherein a resident of the customer premises obtains internet access service via an internet access network. In one embodiment, the method includes measuring a voltage at an electrical outlet of the customer premises to provide voltage data with the device, determining whether the measured voltage is beyond a threshold voltage with the device or a remote computer, transmitting the voltage data over the internet access network of the customer premises to the remote computer from the device, and adjusting a voltage supplied to the power distribution network by the substation if the voltage is beyond a threshold voltage. The method may also include processing at least some of the received voltage data at the remote computer to determine whether to increase a voltage supplied by the substation or decrease a voltage supplied by the substation and further to determine an amount of the increase or decrease (if any).

### BRIEF DESCRIPTION OF THE DRAWINGS

The invention is further described in the detailed description that follows, by reference to the noted drawings by way of non-limiting illustrative embodiments of the invention, in which like reference numerals represent similar parts throughout the drawings. As should be understood, however, the invention is not limited to the precise arrangements and instrumentalities shown. In the drawings:

FIG. 1 illustrates a conventional power grid.

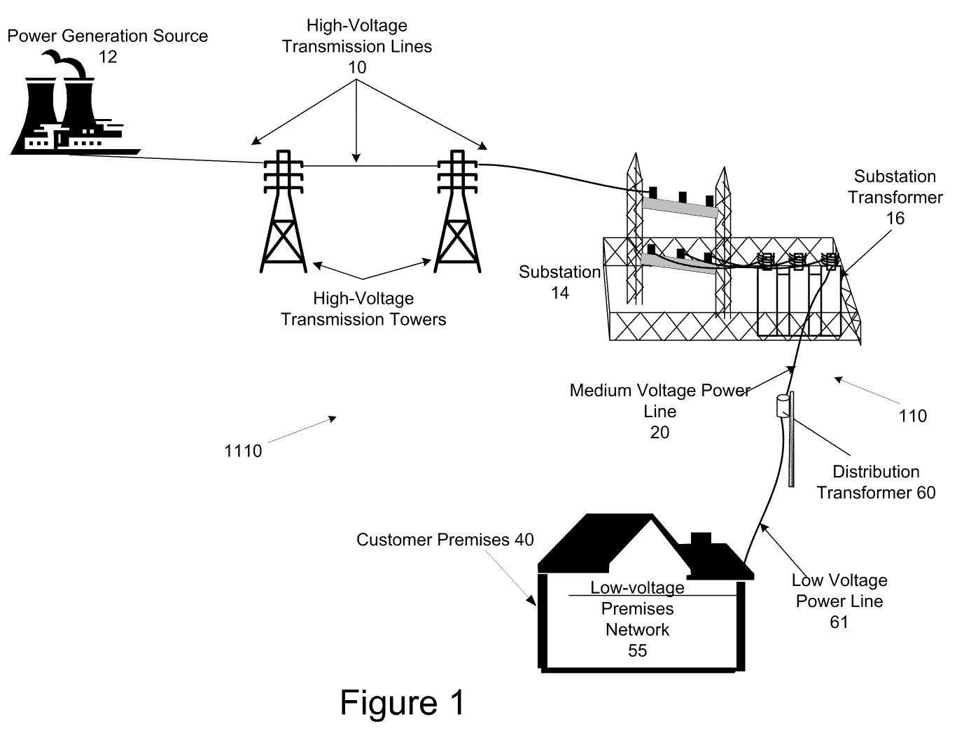

FIG. 2a is a diagram of a power distribution system incorporating a Voltage Control Manager (VCM), in accordance with an example embodiment of the present invention.

FIG. 2b shows a detailed view of a customer premises that includes a Customer Premises Voltage Monitor (CPVM) 400, in accordance with an example embodiment of the present invention.

FIG. 3 depicts a VCM in accordance with an example embodiment of the present invention.

FIG. 4 depicts a customer premises voltage monitor in accordance with an example embodiment of the present invention.

FIG. 5 illustrates a process of monitoring a voltage at a customer premises, in accordance with an example embodiment of the present invention.

FIG. 6 illustrates a method of adjusting a voltage, in accordance with an example embodiment of the present invention.

FIG. 7 illustrates an example wireless photo frame incorporating a CPVM, in accordance with an example embodiment of the present invention.

FIG. 8 is an example set top box incorporating a CPVM, in accordance with an example embodiment of the present invention.

### DETAILED DESCRIPTION OF ILLUSTRATIVE EMBODIMENTS

In the following description, for purposes of explanation and not limitation, specific details are set forth, such as particular networks, communication systems, computers, terminals, devices, components, techniques, data and network protocols, software products and systems, operating systems, development interfaces, hardware, etc. in order to provide a thorough understanding of the present invention.

However, it will be apparent to one skilled in the art that the present invention may be practiced in other embodiments that depart from these specific details. Detailed descriptions of well-known networks, communication systems, computers, terminals, devices, components, techniques, data and network protocols, software products and systems, operating systems, development interfaces, and hardware are omitted so as not to obscure the description.

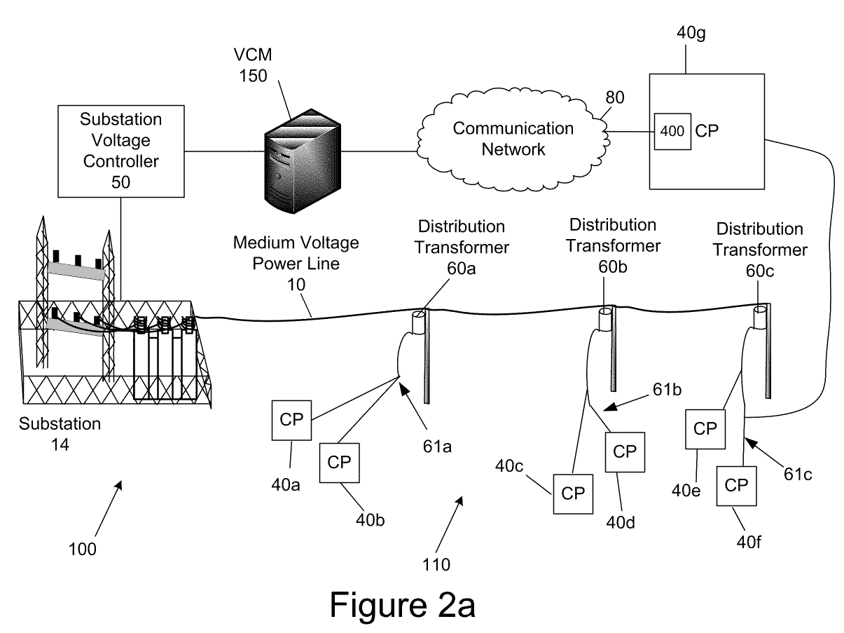

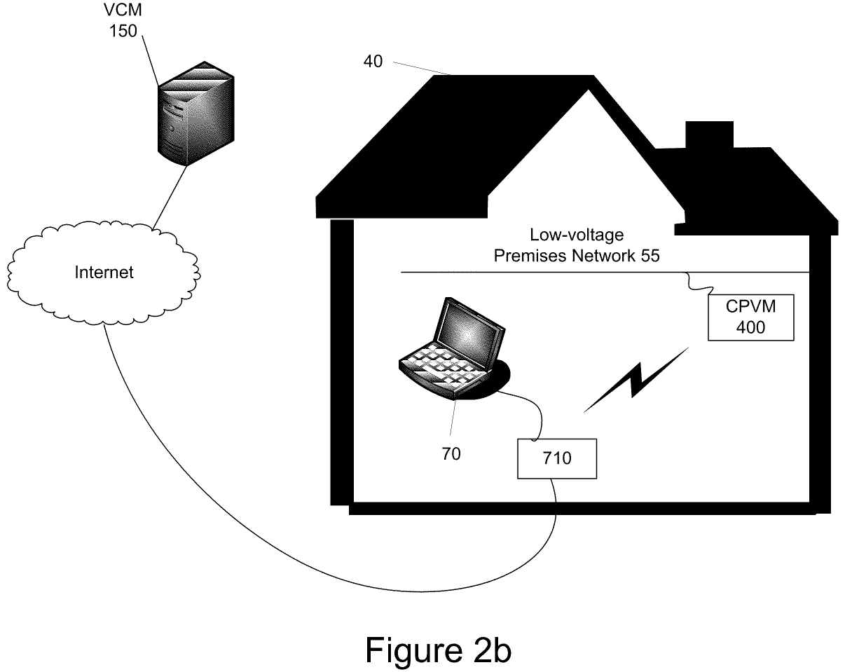

Various embodiments of the present invention provide a system and method of monitoring the voltage delivered to a customer premises 40 and for using real time voltage measurement data to adjust the voltage supplied to the portion of the power grid that provides power to that customer premises. Referring to FIGS. 2a and 2b, a Customer Premises Voltage Monitor (CPVM) 400 may monitor the AC voltage at an electrical outlet 410 within the customer premises 40. The CPVM 400 may send an indication of the voltage monitored to a remote Voltage Control Manager (VCM) 150. The CPVM 400 may formulate a data packet with the measured voltage data for transmission to the VCM 150. The VCM 150 receives the voltage data (e.g., in real-time) measured from the electrical outlet 410 at a customer premises 40, and uses the data to control a voltage supplied to the power grid by the substation 14.

In accordance with the principles disclosed herein, the CPVM 400 allows a utility to accurately determine the voltage at one or more customer premises 40. Through the monitoring of the voltage at one or more customer premises 40, typically at locations experiencing the greatest voltage drops across the power grid, a utility may accurately adjust the voltage supplied to a medium voltage power line 10 in real-time to satisfy a regulatory minimum and maximum voltages. Calculating the voltage to be supplied by the substation 14 eliminates the likelihood that the utility will provide a voltage to the customer premises 40 that is too high (or too low). This in turn may reduce the power requirements of the power generation source. Even a small reduction in power across a power grid can aggregate to enormous cost and environmental savings.

FIG. 2a is a diagram of a power distribution system 100 incorporating a Voltage Control Manager (VCM) 150, in accordance with an example embodiment of the present invention.

Substation voltage controller 50 provides control of the voltage supplied to the medium voltage power line 10 by substation 14. Substation voltage controller 50 may receive instructions to provide a particular voltage to the medium voltage power line 10 from the VCM 150.

In one embodiment, the VCM 150 may communicate with both a substation voltage controller 50 and one or more CPVMs 400 via a communication network 80 (such as the Internet). As discussed, the VCM 150 may send instructions to the substation voltage controller 50 to adjust the voltage supplied to the medium voltage power line 10 by substation 14. The VCM 150 may store various types of parameters, such as location data (e.g., address(es)) of CPVM(s) 400 that are associated with a particular substation 14, historical data for voltage adjustments, etc.). Although the VCM 150 is shown as being a separate component from substation voltage controller 50, the VCM 150 may be integrated with the substation voltage controller 50. In addition, while the VCM 150 is illustrated as communication with only one substation controller 50, the VCM 150 may be communicatively coupled to a plurality of substation voltage controllers 50 to thereby adjust the voltages supplied by a plurality of different substations 14.

Each CPVM 400 may have an associated unique identification (ID) number. This unique ID number (which may comprise a Media Access Control (MAC) address associated with its communication module) may be associated in memory of the VCM 150 with the location of that CPVM 500. In addition, the VCM 150 may store data of a plurality of substations 14 and the locations (e.g., CP 40 addresses) to which they supply power in memory. Thus, the MAC address associated with the CPVM 400 may allow the VCM 150 to determine a particular customer premises (e.g., CP 40g) from a plurality of customer premises 40 communicating a voltage data or a voltage alert (e.g., either a too high voltage or too low voltage), which may be a real-time voltage data and/or voltage alert. The location (e.g., customer premises 40) of a CPVM(s) 400 may be recorded in the VCM 150 through a variety of methods that includes, for example, a web page interface (where the data is supplied by a consumer), a database entry system, a telephone prompt entry system, etc. In this manner, the ID number of the CPVM 400 (e.g., MAC address) that communicates voltage data may be used to determine the associated substation 14 that controls the voltage at that location. Once the substation 14 associated with the particular location is identified, that substation 14 may be provided a voltage adjustment instruction which is used to by the substation voltage controller 50 to supply a new voltage to the medium voltage power line 10. In some embodiments, the substation 14 associated with each CPVM unique ID is stored in memory in advance of receiving communications from the CPVMs 400.

The VCM 150 communicates with the CPVMs 400 via a communication network 80, which may comprise the Internet, a WiMAX network, a mobile telephone network, and/or another suitable network. The CPVM 40 may connect to the network 80 via any suitable communication medium, such as, for example, one or more of a power line (forming part of a power line communication network (PLCS)), a power line of in-home (e.g., HomePlug) network, a twisted pair conductor (e.g., forming part of a DSL network), a wireless connection, a coaxial cable (forming part of a cable network) and/or any other suitable medium.

Many customer premises 40 subscribe to an Internet Access Service and thus already have access to the Internet. In some embodiments, the CPVM 400 may use the Internet Access Service, used by the residents to access the internet, to communicate with the VCM 150 as illustrated in FIG. 2b. The CPVM 400 may communicate with a router or modem 710 (in the customer premises 40) to communicate through a cable network, Digital Subscriber Line (DSL) network, wireless network, or other network that provides Internet access for residences of the customer premises 40.

One or more customer premises 40 may be selected by a utility as desired points within the power distribution system 100 that will have their voltage monitored. For example, referring to FIG. 2a customer premises 40g may be selected by a utility as a desired point within the power distribution system 100 that will have their voltage monitored. Customer premises 40g may be associated with a substation 14 within the memory of VCM 150. An indication of either a high voltage or a low voltage at customer premises 40g may result in its associated substation 14 being instructed to adjust its voltage accordingly to be closer to a regulatory requirement, minimum or maximum. Adjustment of a voltage at the substation 14 may be an iterative process that results in small changes in the voltage supplied by the substation 14, with the resultant voltage supplied to the customer premises 40g being then determined. The resultant measured voltage is further used to again adjust the voltage supplied by the substation 14. This process may continue as needed to make the voltage supplied by the substation 14 as close to a regulatory minimum (in this embodiment) as desired by a utility. The process may be repeated on an ongoing basis since the voltages at customer premises may vary due to climate conditions and/or the load on the substation.

Although only a single customer premises 40g is shown to include a CPVM 400 in FIG. 2a, a utility may select any number of customer premises 40 as locations within the power distribution system 100 to monitor the voltage. For example, a utility may select multiple customer premises 40 located at approximately equal distances from a substation (and that may experience similar or lower voltages) to monitor a voltage. Monitoring of multiple customer premises 40 that are likely to similar voltages may allow a utility to assess whether their estimations for other parts of the power distribution system 100 are accurate to real world voltages for those particular locations.

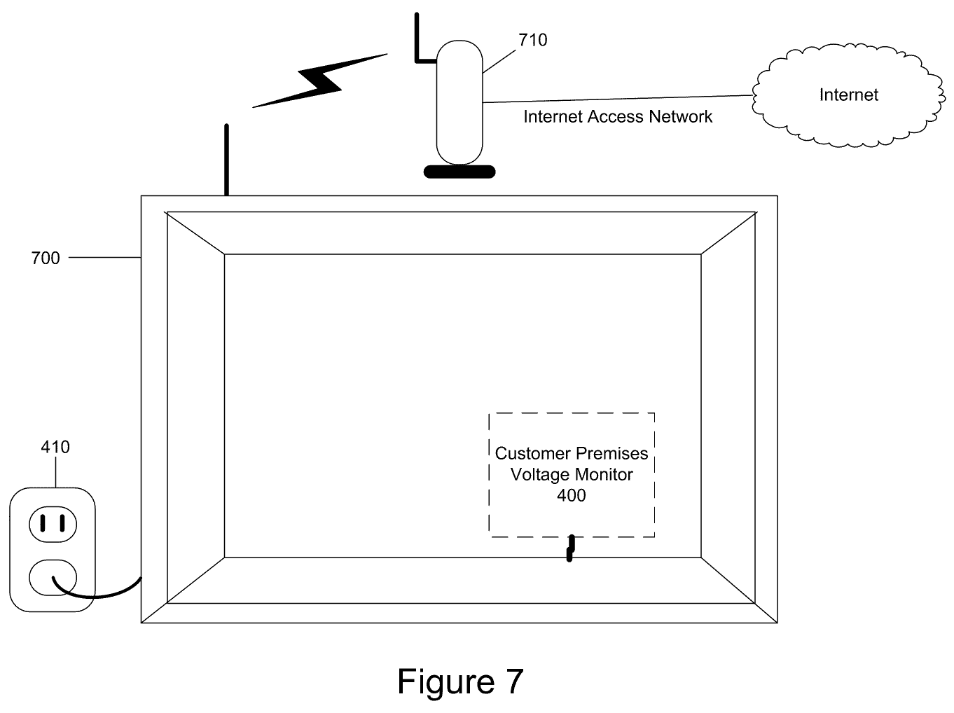

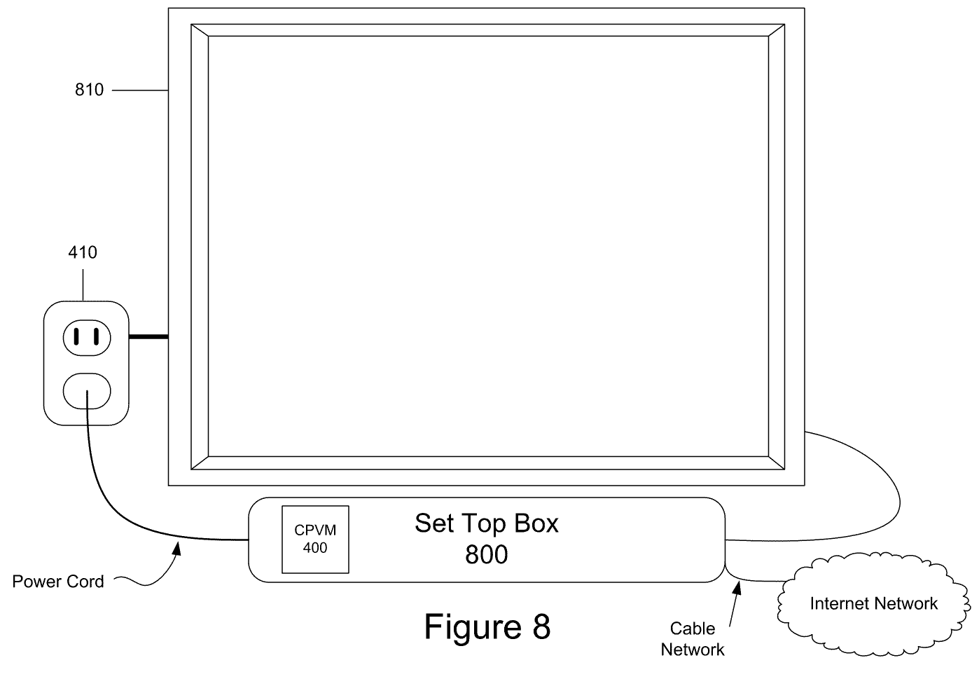

FIG. 2b shows a detailed view of a CP 40 that includes a CPVM 400, in accordance with an example embodiment of the present invention. As illustrated, many power customers already subscribe with an Internet Service Provider (ISP) for Internet service. One or more personal computers 70 may connect to a router/modem 710 that allows users within the CP 40 to communicate with the Internet as illustrated in FIG. 2b. In accordance with the principles disclosed herein, a CP 40 may further include a CPVM 400 that may access the internet via a router/modem 710 that is used by other devices to communicate via the internet. The CPVM 400 may communicate with the router/modem 710 via a wired connection or a wireless connection, depending upon the particular application of the CPVM 400. Two examples of a CPVM 400 connecting to the internet through an existing data connection within a CP 40 are shown in FIGS. 7 and 8, and depending upon convenient access of the router/modem 710 within the CP 40.

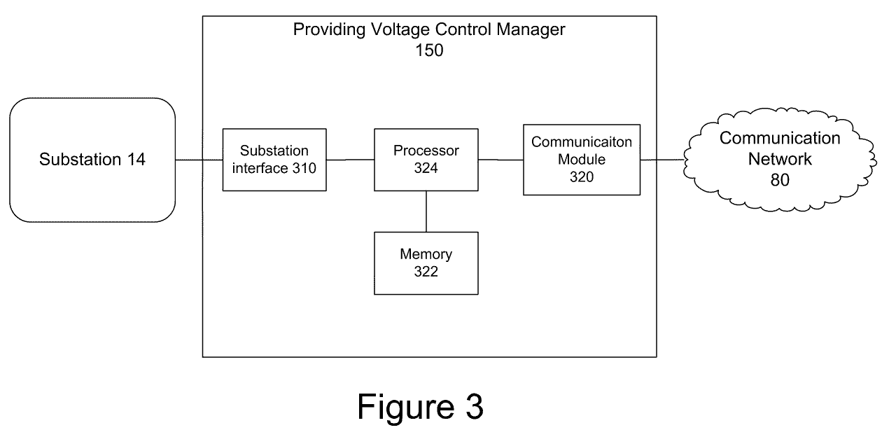

FIG. 3 depicts a voltage conservation manager (VCM) 150 in accordance with an example embodiment of the present invention. In particular, the VCM 150 may include a processor 324, a substation interface 310 and a communication module 320. In some embodiments, the VCM 150 may be a general purpose computer with a processor executing program code stored in memory to perform the functions disclosed herein and store the data disclosed herein.

Communication module 320 allows the VCM 150 to communicate with one or more CPVM(s) 400. Communication module 320 may be any of a variety of communications modules suitable for a particular communication medium. Communication module 320 may be a telephone line modem, an Ethernet adapter, a fiber optic adapter, a wireless network adapter, a mobile telephone transceiver, a cellular network adapter, etc. Communication module 320 may include an appropriate transmit buffer and receive buffer, as is known within the art. Thus, communication module 320 may be any type of data interface that allows the VCM 150 to communicate with a CPVM 400.

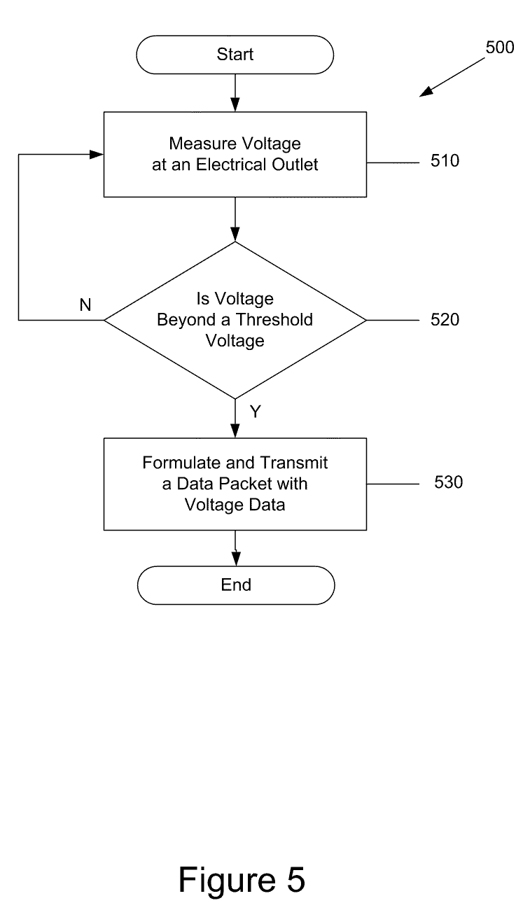

Substation interface 310 is used to communicate with the substation 14 and may include a transceiver for communicating with the substation controller 50. The processor 324 may formulate and send one or more voltage adjustment instructions to substation 14 via the substation interface 310. As discussed in more detail with relation to FIG. 5, processor 324 may calculate a new voltage for substation 14 based on a voltage as measured at a CP 40. Processor 324 may determine the substation 14 that is associated with a particular CPVM 400 (i.e., the customer premises 40 in which the CPVM 400 is located) providing voltage data or reporting a voltage that is either too high or too low. Depending upon the particular equipment used at a substation 14, processor 324 forms an appropriate voltage adjustment instruction to instruct substation 14 to change the supplied voltage accordingly.

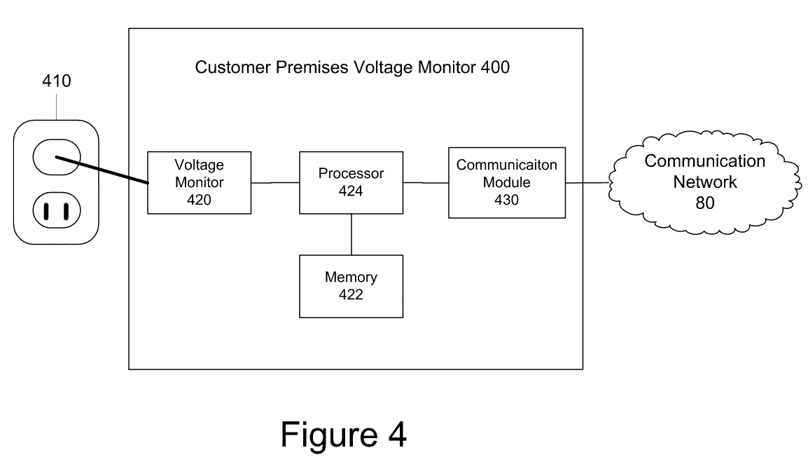

FIG. 4 depicts a customer premises voltage monitor 400 in accordance with an example embodiment of the present invention. In particular, the customer premises voltage monitor 400 may include a voltage monitor 420, communication module 430, a processor 424 and a memory 422.

The electrical outlet 410 being used to measure voltage at the CP 40 may be any electrical outlet 410 includes 110-120 volt outlet or a 220-240 volt outlet, commonly used to power a clothes dryer. One benefit of using a 220-240 volt outlet is that both energized low voltage power line conductors are present there so that the CPVM 400 can measure the voltage to ground on each low voltage energized conductor.

The communication module 430 allows the CPVM 400 to communicate with a VCM 150. Communication module 430 may be any of a variety of communications modules that are suitable for a particular communication medium. Communication module 430 may be a telephone line modem, an Ethernet adapter, a fiber optic adapter, a wireless network adapter, a mobile telephone network transceiver, a cellular network adapter, etc. Communication module 430 may include an appropriate transmit buffer and receive buffer, as is known within the art. Thus, communication module 430 may be any type of data interface that allows the CPVM 400 to communicate with a VCM 150.

The voltage monitor 420 receives the AC voltage from an electrical outlet 410 and measures the RMS voltage received. Thus, the voltage monitor 420 may include an analog to digital converter or a digital signal processor. The measurement data is provided to processor 424. Processor 424 may provide voltage data and/or an alert to be transmitted by communication module 430, as described in more detail in FIG. 5. In addition to measuring the voltage over time (i.e., monitoring the voltage), the voltage monitor (or more generally the electric monitor) may also be configured to measure and monitor the power factor, harmonics, voltage noise, voltage spikes, peak-to-peak voltage.

Memory 422 may store voltage data as measured by the voltage monitor 420. Memory 422 may also store a unique serial number for the CPVM 400 that allows a VCM 150 to uniquely identify the CPVM 400 on a power grid 100. In some embodiments, memory 422 may store program code to be executed by processor 424 as well as parameters such as thresholds (minimum and maximum voltages) that are used as a basis to transmit an alert to the VCM 150, if the CPVM 400 is so configured. More specifically, the processor 424 may compare the measurement data from the voltage monitor 420 with the minimum and maximum threshold data retrieved from memory and, if a threshold is exceeded (too high or low) the processor 424 transmits an alert to the VCM 150 via the communication module 430 in real-time (or near real-time). Thus, the VCM 150 may receive the alert or voltage data within five minutes, more preferably within two minutes, even more preferably within one minute, and yet more preferably within fifteen seconds of the measurement. In addition or alternately, VCM 150 may request data from the CPVM 400 and the processor 424 retrieves the time stamped data from memory 422 and transmits the time stamped data to the VCM 150.

The VCM 150 (or other computer system) may transmit program code, gateway IP address(es), and/or threshold values for storage in memory 422 of the CPVM 400 to be used by the processor 424 to perform various processing.

The CPVM 400 may be a dedicated box or “brick” (mechanical form fit sized like a deck of playing cards) that plugs directly into an electrical outlet 410 (e.g., wall socket), similar to a wall socket plug-in transformer. Communication module 430 also may plug into the communication medium (for connection to the Internet) through a hardwired connection (e.g., Ethernet connection) or connect via a wireless connection (e.g., WiFi). As illustrated in FIG. 2b, an in-home modem, set top box, and/or modem/router 710 be communicatively coupled (either via a wire, power lines, wireless, etc.) to the CPVM 400 and may be used to connect the communication module 430 to the communication medium for communications via the internet.

FIG. 5 is a process 500 of monitoring a voltage at a customer premises 40 and identifying an alert condition, in accordance with an example embodiment of the present invention. As discussed, at step 510 the RMS AC voltage at the customer premises 40 may be measured by the CPVM 400. Processor 424 may store the data of measured voltages in memory 422. In some embodiments, other parameters (discussed above) may also be measured and stored. The processor 424 may store additional data such as the time of measurement, the date of measurement, etc. Thus, a history of voltages measured over a period of time may be stored in the memory 422 to allow a historical determination of changing voltages.

At step 520, processor 424 may determine if a measured RMS voltage is beyond a threshold voltage (either greater than a high threshold or less than a low threshold). For example, processor 424 may compare the measured voltage with each of a high and low threshold to determine if the measured voltage is above a high threshold or below a low threshold. As a more specific example, the processor 224 (or alternately the DSP (Digital Signal Processor) forming part voltage monitor 420) may determine if the measured voltage is within six percent of a nominal voltage (e.g., 120 volts) that is, determine if the measured voltage is below 112.8 volts RMS or above 127.2 volts RMS.

If at step 520 the process 500 determines that the measured voltage is not beyond a threshold voltage, the process branches to step 510 to take additional measurements. In this manner the process 500 may continuously monitor for a voltage that is either too high or too low, and may provide real-time voltage data to the VCM 150. If at step 520 the process determines that the measured voltage is beyond a threshold voltage, the process branches to step 530.

At step 530, the voltage data measured in step 510 may be formulated into one or more data packet(s) by processor 424 to provide an alert by reporting (to the VCM 150) in real-time (or near real-time) voltages that are beyond a threshold. The transmission (or alert) may also include time stamp data for the measurement and information identifying the CPVM 400 to allow the VCM 150 to determine the location of the voltage measurement (and the substation providing the voltage to that location). The voltage data from each (or some) measurements also may be stored in memory 422. In addition to transmitting an alert, processor 424 may retrieve the most recently stored voltage data (e.g., the last hour or day), and/or more historical voltage data (e.g., the last week or month), from the memory 422 and provide the voltage data to communication module 430 for transmission to the VCM 150. The transmission of data may be performed by processor 424 in accordance with program code that causes periodic data transmission or may be performed in response to a to receiving a request for data from the VCM 150. The data packet(s) may be placed into a transmit data buffer of communication module 430. Communication module 430 may then transmit the voltage data packet(s) over the communication medium, through the internet to the VCM 150.

In some embodiments, the communication of voltage data provides an alert that a voltage is either too high or too low. In some embodiments, voltage data may be communicated with a VCM 150 on a periodic basis (either in real time or not), whether the measured voltage is considered a “normal” value or not. In such an instance, the VCM 150 may make the sole determination as whether the voltage at a CP 40 is either too high or too low.

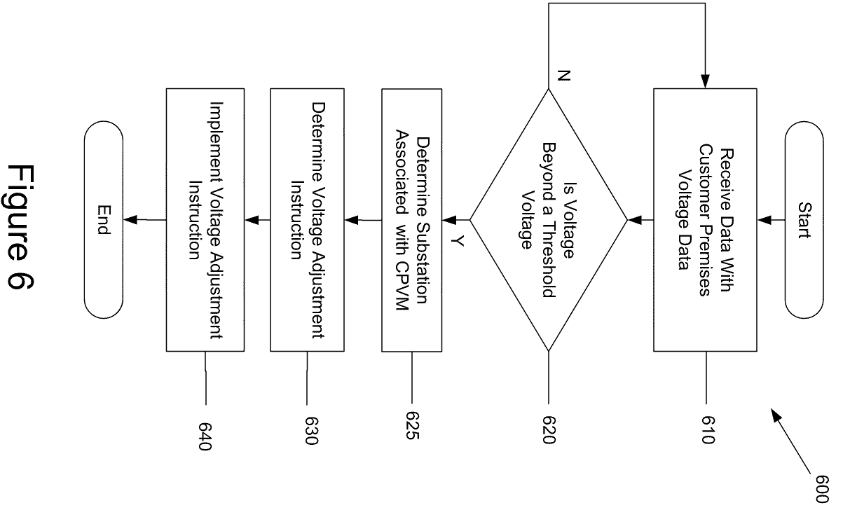

FIG. 6 illustrates a method of adjusting a voltage at a substation 14, in accordance with an example embodiment of the present invention. As discussed, at step 610 the VCM 150 may receive one or more data packets with voltage data as measured at a customer premises 40. The data may also include information identifying the CPVM 400 making the measurement and time and date data. More specifically, the data comprising voltage data from one or more measurements by a CPVM 400 in step 510 (and other data) and that are formulated into one or more data packets in step 530 is received by a receive buffer within communication module 320.

At step 620, processor 324 may determine if a measured voltage is beyond a threshold voltage value (either greater than a high threshold value or less than a lower threshold value). For example, processor 324 may compare the measured voltage with each of a high and low threshold to determine if the measured voltage is above a high threshold or below a low threshold. If at step 620 the process 600 determines that the measured voltage is not beyond a threshold voltage, the process branches to step 610 to wait for additional data. In some embodiments, the received data may be stored in memory for later processing. If at step 620 the process determines that the measured voltage is beyond a threshold voltage, the process branches to step 625.

At step 625, processor 324 determines the particular substation 14 that is associated with the customer premises 40 has indicated a voltage that is either too high or too low. For example, the processor may query the database for a location (e.g., an address) associated with the identifying information of the CPMV 400, which is received with the voltage data. Upon determining the location, the processor determines the substation supplying power to that location by, for example, querying a database. Note that in some embodiments, this step may be omitted if, for example, each VCM 150 of multiple VCMs 150 control only a single substation.

At step 630, the voltage data received from the CPVM 400 in step 610 may be used to determine a voltage adjustment instruction by processor 324. Processor 324 may retrieve the most recently received voltage data (and, in some instances, the most recent voltage adjustment instruction) from the memory 322 and formulate an appropriate substation voltage adjustment instruction in accordance with the requirements of the particular substation 14 employed to control the voltage on the medium voltage power line 10. A historical record of the substation voltage adjustment instruction may be stored in the voltage adjusting storage 322. The voltage adjustment instruction may be either a new voltage to be supplied (e.g., 15,152 volts) or a voltage adjustment (e.g., increase by 93 volts or decrease by 70 volts). In some instances, the voltage instruction may be transmitted to the substation controller 50, in which case the data packet(s) may be placed into a transmit data buffer of voltage adjusting module 310 for transmission to substation 14. In other embodiments the VCM 150 may form part of the same computer system as controller 50, in which case transmission may not be necessary.

At step 640, the substation 14 implements the voltage adjustment instruction formulated in step 630 to appropriately adjust substation 14. Thus, substation voltage controller, upon receipt of the voltage adjustment instruction, may respond appropriately causing the substation 14 to adjust the voltage placed on the medium voltage power line 10 in accordance with the voltage adjustment instruction.

Step 520 may determine if a voltage is either too high or too low as measured at a customer premises 40. Step 620 also may determine if a voltage is too high or too low as determined by the VCM 150. However, the VCM 150 may use different threshold voltages for its determinations than those used by the CPVMs 400. For example, the CPVMs 400 may report voltages beyond thresholds and thereby provide a preliminary alert that a voltage is beyond a first threshold (and getting close to a second threshold), while the VCM 150 may, for example, make the determination that the voltage is beyond the second threshold warranting a voltage adjustment. Thus, the CPVM 400 alerts may be used to give a warning that, should loads change significantly, the voltage at a customer premises 40 is at risk of dropping below a threshold voltage (the threshold used by VCM).

In this manner, a pre-established threshold voltage that controls whether the voltage is adjusted by the substation 14 can be more easily controlled at a centralized location, such as the VCM 150. This may be helpful in the event that a pre-established threshold voltage requires adjustment.

FIG. 7 illustrates an example wireless photo frame 700 incorporating a CPVM 400, in accordance with an example embodiment of the present invention. In particular, wireless photo frame 700 may include a CPVM 400 as described in detail with relation to FIG. 4.

A utility may desire certain of its customers to use a CPVM 400. However, some customers may not want a CPVM 400 that is a wall plug “brick” that may be unsightly or that provides no other function. To entice a customer into using a CPVM 400 in their customer premises 40, a utility may offer its customers an aesthetically pleasant device (or other device) that incorporates a CPVM 400, but that also includes alternate functionality. A wireless photo frame 700 may be such a device.

Many utility customers already have a wireless network such as a WiFi network within their homes. WiFi networks are typically established within customer premises 40 to allow residence to connect to the Internet from a wireless device. The wireless photo frame 700, in accordance with the principles disclosed herein, may communicate via an existing WiFi network to gain assess to a communication medium to communicate via the Internet.

In some such embodiments, the CPVM 400 may not include a separate communication module 430 and a power supply, and instead rely on a communication module and a power supply forming part of the photo frame 700 and shared by functional components of the photo frame 700. In other embodiments, the memory and processor used to perform voltage monitoring and comparison function (i.e., CPVM 400 functions) may also perform conventional photo frame function (storing photos, sequencing through photos, etc.).

In operation, the wireless photo frame 700 communicates voltage data, as measured from electrical outlet 410, via a wireless network router/modem 710 to communication medium 80. The wireless network router/modem 710 formulates one or more appropriate packets, depending upon the particular communication medium 80 employed, to communicate measured voltage with a remote VCM 150. The VCM 150 may adjust a voltage at a substation 14 based on the received measured voltage, as discussed above in relation to FIG. 3.

FIG. 8 is an example set top box 800 incorporating a CPVM 400, in accordance with an example embodiment of the present invention. In particular, the set top box 800 may include a CPVM 400 as described in detail with relation to FIG. 4.

A set top box 800 is used to allow a user to control the programming provided to the television 810. The set top box 800 is also connected to a bi-directional network that provides programming to the set top box. Because the set top box includes a processor, storage (e.g., memory), and a communication module, some these (e.g., the communication module) or all of these components may be used by the CPVM 400 functionality so that fewer extra components are necessary.

In operation, the set top box 800 communicates voltage data via the internet to the VCM 150 as measured from an electrical outlet 410 to which the set top box is plugged in. The VCM 150 may adjust a voltage at a substation 14 based on the received voltage data, as discussed above in relation to FIG. 3.

In some embodiments, the CPVM 400 may be connected to a set top box 800 through an external communication port, such as a Universal Serial Bus (USB) port, External Serial Advanced Technology Attachment (eSATA) port, etc. In this type of implementation, the CPVM 400 may connect to both an external communication port of the set top box 800 to communicate with the VCM 150 and an electrical outlet 410 to measure a voltage at a CP 40.

FIGS. 7 and 8 illustrate but two possible devices that the CPVM 400 disclosed herein may be integrated with. One of ordinary skill in the art would recognize that the CPVM 400 may be integrated with other devices that have alternate functionality and have communication capabilities, preferably with the Internet. For example, the CMVM 400 may be integrated into a modem such as a cable modem, DSL modem, or power line modem, for communications over a cable network, DSL network, or power line communication system, respectively, to the VCM 150 via the Internet.

As discussed above, in addition to measuring the voltage over time (i.e., monitoring the voltage), the CPVM (400 (or more generally the customer premise electricity monitor) may also be configured to measure and monitor the power factor (i.e., the difference between the phase angle of the voltage and current received by the device 400), voltage harmonics, voltage noise, voltage spikes, average voltage, peak-to-peak voltage, and other such parameters. In addition, the failure of the VCM 150 to receive a response to a control message (e.g., a request for data or status) from one or more CPVMs 400 may be used by the VCM 150 (or other computer system) to determine the location(s) of a power outage. Upon power up, the CPVMs 400 may be programmed to initiate communications with the VCM 150. Thus, data and/or notifications from the one or more CPVMs 400 may be used by the VCM 150 to identify the location(s) of a power restoration (e.g., after an outage). Furthermore, wherein a CPVM 400 measures the voltage of both energized low voltage conductors (e.g., at a 240V socket often used for a clothes dryer), the CPVM 400 may detect a disparity (difference) in the two voltages that exceeds a threshold disparity, which may be a signature (or predictive) of a failing transformer. In such a scenario, the CPVM 400 may be programmed to transmit an alert, which may be processed by the VCM 150 to dispatch personnel to repair or replace the distribution transformer serving the customer premise.

It is to be understood that the foregoing illustrative embodiments have been provided merely for the purpose of explanation and are in no way to be construed as limiting of the invention. Words used herein are words of description and illustration, rather than words of limitation. In addition, the advantages and objectives described herein may not be realized by each and every embodiment practicing the present invention. Further, although the invention has been described herein with reference to particular structure, materials and/or embodiments, the invention is not intended to be limited to the particulars disclosed herein. Rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention.

What is claimed is:

1. A method of controlling the voltage supplied to a customer premises that is supplied power from a substation via a power distribution network, wherein a resident of the customer premises obtains internet access service via an internet access network, the method comprising:
measuring a voltage at an electrical outlet of the customer premises to provide voltage data with a device;
determining whether the measured voltage is beyond a threshold voltage;
transmitting the voltage data over the internet access network of the customer premises to a remote computer from the device; and
adjusting a voltage supplied to the power distribution network by the substation if the voltage is beyond a threshold voltage.

2. The method according to claim 1, further comprising:
at the remote computer, processing at least some received voltage data to determine whether to:
increase a voltage supplied by the substation; or
decrease a voltage supplied by the substation.

3. The method according to claim 1, wherein measuring a voltage comprises:
measuring a voltage on a first energized low voltage conductor referenced to ground; and
measuring a voltage on a second energized low voltage conductor referenced to ground.

4. The method according to claim 1, further comprising a voltage controller operable to control the voltage supplied by the substation and wherein the voltage controller is configured to respond to an instruction from the remote computer, the method further comprising:
transmitting a voltage adjustment instruction from the remote computer to the voltage controller; and
wherein said adjusting a voltage by the substation is performed in response to said voltage controller receiving the voltage adjustment instruction.

5. The method according to claim 1, wherein the internet access network comprises a cable network and the customer premises includes a cable modem located therein that is connected to the cable network and is configured to access the internet; and
wherein the voltage data is transmitted to the remote computer via a data path that includes the cable modem and the cable network.

6. The method according to claim 1, wherein the customer premises includes a DSL modem located therein that is separate from the device and wherein the DSL modem is configured to access the internet; and
wherein the voltage data is transmitted to the remote computer via a data path that includes the DSL modem.

7. The method according to claim 1, wherein the voltage data is transmitted to the remote computer via a data path that includes a mobile telephone network.

8. The method according to claim 1, wherein said transmitting is performed after said determining and in response to said determining.

9. The method according to claim 1, further comprising:
receiving a request for data at the device; and
wherein said transmitting by the device is performed in response to receiving said request.

10. The method according to claim 1, wherein said transmitting comprises periodically transmitting the voltage data.

11. The method according to claim 1, wherein said determining is performed after said transmitting.

12. The method according to claim 1, wherein the transmitted voltage data comprises an alert that the measured voltage is beyond a threshold voltage.

13. The method according to claim 1, further comprising at the remote computer:
identifying a substation that supplies power to the customer premises based on information transmitted by the device.

14. The method according to claim 13, wherein said identifying comprises:
determining a location of the device based on information transmitted by the device; and
identifying the substation based on the location of the device.

15. The method according to claim 1, wherein the customer premises includes therein a modem and a router connected to the modem, wherein the modem is connected to the internet access network and the router is configured to route at least some data received by the modem from the internet to a general purpose computer, and
wherein the voltage data is transmitted to the remote computer via a data path that includes the router, the modem, the internet access network, and the Internet.

16. The method according to claim 1, further comprising storing photos and displaying photos with the device.

17. A method of controlling the voltage supplied to a plurality of customer premises that are supplied power from one or more substations via a power distribution network, wherein a resident of each of the plurality of customer premises obtains internet access service via an internet access network, comprising:
providing a voltage measurement device that receives power from an electric outlet in each of the plurality of customer premises;
with each voltage measurement device in each respective customer premises, measuring a voltage of the power received from an electrical outlet to provide voltage data;
with at least one voltage measurement device, transmitting the voltage data over the internet access network of the customer premises to a remote computer from the device;
determining whether the voltage data of each voltage measurement device is beyond a threshold voltage; and
adjusting a voltage supplied to the power distribution network by a substation if the voltage data provided by at least one voltage measurement device is determined to be beyond a threshold voltage.

18. The method according to claim 17, wherein said determining is performed by the remote computer.

19. The method according to claim 18, further comprising determining whether voltage data received from each voltage measurement device that transmits voltage data is beyond a second threshold.

20. The method according to claim 17, wherein said determining is performed by each voltage measurement device for the voltage data provided by that device.

21. The method according to claim 17, further comprising at the remote computer:
for voltage data that is determined to be beyond a threshold voltage, identifying a substation that supplies power to a customer premises based on information transmitted by the voltage measurement device that transmitted the voltage data;
providing a voltage adjustment instruction to a controller associated with the identified substation; and
wherein said adjusting is performed by the identified substation.

22. The method according to claim 21, wherein said identifying comprises:
determining a location of the voltage measurement device transmitting the data based on information transmitted by the voltage measurement device; and
identifying the substation based on the location of the voltage measurement device.

23. The method according to claim 17, wherein said transmitting is performed after said determining and in response to said determining.

24. The method according to claim 17, further comprising:
transmitting data of one or more threshold voltages to each of the voltage measurement devices for storage therein.

25. The method according to claim 17, further comprising:
communicating a request for data to the at least one voltage measurement device; and
wherein said transmitting is performed in response said request.

26. The method according to claim 17, wherein said transmitting comprises periodically transmitting the voltage data.

27. The method according to claim 17, wherein said determining is performed after said transmitting.

28. The method according to claim 17, wherein at least one of the voltage measurement devices is configured to store and display photos.

29. The method according to claim 17, wherein said transmitting is performed by a group of the plurality of the voltage measurement devices.

30. A device for providing substantially real-time voltage data of a customer premises, wherein a resident of the customer premises accesses the internet via an internet access network, comprising:
a housing;
a processor disposed in said housing;
a memory disposed in said housing;
an electrical plug connected to said housing and configured to mate with an electrical outlet;
a voltage measurement module configured to measure an alternating current (AC) voltage conducted by said electrical plug from an electrical outlet of the customer premises and to provide data of the measured voltage to said processor;
wherein said processor is configured to store data of the measured voltage received from voltage measurement module in said memory; and
a communication module configured to receive data from said processor and to transmit received data via the internet access network to a remote computer.

31. The device according to claim 30, wherein said processor is configured to determine whether a measured voltage is beyond a threshold voltage.

32. The device according to claim 31, wherein said processor is configured to cause said communication module to transmit an alert to the remote computer if the measured voltage is beyond a threshold voltage.

33. The device according to claim 32, wherein the alert includes information identifying the device and data of the measured voltage.

34. The device according to claim 30, wherein in response to receiving at least some data from the device, the remote computer is configured to cause a change in the voltage supplied to the customer premises.

35. The device according to claim 30, wherein the internet access network is used by one or more general purpose computers operated by the resident to access one or more web servers.

36. The device according to claim 30, wherein said housing houses one or more components of a photo frame.

37. The device according to claim 30, wherein said communication module comprises a wireless transceiver.

38. The device according to claim 30, wherein said communication module is configured to communicate with a router that routes data from the Internet to one or more general purpose computers.

39. The device according to claim 30, wherein said processor is configured to process the data of the measured voltage and to cause said communication module to transmit data of at least one of the group of: a power factor, a voltage harmonic, and a peak voltage.

40. The device according to claim 30, wherein the remote computer is configured to process received data of the measured voltage to determine data of at least one of the group of: a power factor, a voltage harmonic, and a peak voltage.

41. The device according to claim 30, wherein said processor is configurable via program code to cause said communication module to transmit data of the measured voltage within sixty seconds of a measurement of the voltage by said voltage measurement module.
